(19) United States
(12) Patent Application Publication
(10) Pub. No.: US 2026/0247106 A1
(43) Pub. Date: Aug. 20, 2026

(54) TRACKING DEVICE HAVING LABEL-LIKE FORM FACTOR AND ASSOCIATED TRACKING METHODS

(71) Applicant: LandAirSea Holdings, LLC, Boca Raton, FL (US)

(72) Inventor: Robert M. Wagner, Dorado (PR)

(21) Appl. No.: 19/055,922

(22) Filed: Feb. 18, 2025

(51) Int. Cl. H04W 4/029

(52) U.S. Cl. CPC H04W 4/029

(57) ABSTRACT

Tracking devices and methods for tracking an object are provided. The tracking device includes a system-on-chip comprising wireless communication circuitry configured to facilitate wireless communication with an associated device and one or more processors coupled to the wireless communication circuitry and configured to cause the tracking device to transmit a location beacon to the associated device for updating a location of the tracking device via the associated device. The tracking device has a label-like form factor, such that the tracking device is configured to be attached to a surface of an object. The tracking device can include an antenna, an accelerometer, a flexible zinc ion battery, a piezoelectric element and a light emitting diode for outputting audible and visual alerts, and a tearable portion for automatically powering the tracking device, using the battery, upon initial displacement of the tearable portion from a main portion of the tracking device.

### FIELD

This disclosure is directed to a tracking device and associated methods for tracking a device, and more particularly to a tracking device having a label-like form factor, such that the tracking device is configured to be attached to a surface of an object, and associated methods for tracking an object to which such a tracking device is attached.

### BACKGROUND

Tracking devices are typically used to track various objects, such as by being placed in near proximity to an object to be tracked. Many existing tracking devices include a GPS module and/or rely on cellular modems for tracking. However, such devices can often require circuitry that is relatively power intensive and expensive, thereby resulting in a tracking device that is undesirably inflexible, bulky, and expensive.

As such, it would be desirable to provide a tracking device having a label-like form factor, such that the tracking device can be attached to a surface of an object to be tracked (e.g., a personal asset) and transmit location beacons to nearby devices to share, determine, and/or update a location of the tracking device via such devices.

### BRIEF SUMMARY

In a first aspect, a tracking device is provided. The tracking device includes a system-on-chip. The system-on-chip includes wireless communication circuitry. The wireless communication circuitry is configured to facilitate wireless communication with an associated device. The tracking device include one or more processors. The one or more processors are coupled to the wireless communication circuitry. The one or more processors are configured to cause the tracking device to transmit a location beacon to the associated device for updating a location of the tracking device via the associated device. The tracking device has a label-like form factor, such that the tracking device is configured to be attached to a surface of an object.

In certain aspects, the wireless communication circuitry can include an antenna.

In certain aspects, the system-on-chip can further include an accelerometer configured to detect motion of the tracking device.

In certain aspects, the one or more processors can be configured to transmit the location beacon via Bluetooth low energy.

In certain aspects, the one or more processors can be configured to transmit the location beacon via near-field communications.

In certain aspects, the tracking device can further include a light emitting diode. The one or more processors can be further configured to cause the tracking device to output a visual alert via the light emitting diode.

In certain aspects, the tracking device can further include a piezoelectric element (e.g., speaker, buzzer). The one or more processors can be further configured to cause the tracking device to output an audible alert via the piezoelectric element.

In certain aspects the tracking device can further include a battery, such as a flexible zinc ion battery.

In certain aspects the tracking device can further include a tearable portion. In some such aspects in which the tracking device includes a tearable portion, the tracking device can further include a battery, and the one or more processors can be configured to automatically cause the battery to begin powering the tracking device upon initial displacement of the tearable portion from the main portion of the tracking device. In some such aspects in which the tracking device includes a tearable portion, the one or more processors can be configured to automatically begin transmitting the location beacon to the associated device upon initial displacement of the tearable portion from a main portion of the tracking device.

In a second aspect, a method for tracking an object is provided. The method includes attaching a tracking device having a label-like form factor to a surface of the object. The method includes transmitting a location beacon from the tracking device to an associated device in wireless communication with the tracking device for updating a location of the tracking device via the associated device.

In certain aspects, a visual alert can be outputted via a light emitting diode of the tracking device and/or an audible alert can be outputted via a piezoelectric element of the tracking device.

In certain aspects, a tearable portion of the tracking device can be initially displaced (e.g., cut or torn) from a main portion of the tracking device. In some aspects, as a result of such initial displacement of the tearable portion from the main portion of the tracking device, the tracking device can be caused to automatically cause a battery of the tracking device to begin powering the tracking device. In some aspects, as a result of such initial displacement of the tearable portion from the main portion of the tracking device, the tracking device can be caused to automatically transmit the location beacon to the associated device.

In a third aspect, a tracking device is provided. The tracking device includes a system-on-chip. The system-on-chip includes wireless communication circuitry. The wireless communication circuitry includes an antenna and is configured to facilitate wireless communication with an associated device. The tracking device includes a flexible zinc ion battery. The tracking device includes a light emitting diode. The tracking device includes a piezoelectric element. The tracking device includes a tearable portion. The tracking device includes one or more processors. The one or more processors are coupled to the wireless communication circuitry. The one or more processors are configured to cause the battery to automatically begin powering the tracking device upon initial displacement of the tearable portion from a main portion of the tracking device. The one or more processors are configured to cause the tracking device to automatically transmit a location beacon to the associated device via Bluetooth low energy or near-field communications for updating a location of the tracking device via the associated device. The one or more processors are configured to cause the tracking device to output a visual alert via the light emitting diode and/or an audible alert via the piezoelectric element. The tracking device has a label-like form factor, such that the tracking device is configured to be attached to a surface of an object.

In certain aspects, the battery can have a thickness of about 0.8 mm or less, the light emitting diode 150 can have a thickness of about 0.5 mm or less, and the piezoelectric element can have a thickness of about 1 mm or less.

Additional embodiments and features are set forth in part in the description that follows, and will become apparent to those skilled in the art upon examination of the specification or may be learned by the practice of the disclosed subject matter. A further understanding of the nature and advantages of the disclosure may be realized by reference to the remaining portions of the specification and the drawings, which forms a part of this disclosure.

### BRIEF DESCRIPTION OF THE DRAWINGS

The description will be more fully understood with reference to the following figures and data graphs, which are presented as various embodiments of the disclosure and should not be construed as a complete recitation of the scope of the disclosure, wherein:

FIG. 1 shows a system including a tracking device attached to an object and in wireless communication with an associated device according to an illustrative embodiment of the present disclosure;

FIG. 2 shows a tracking device according to an illustrative embodiment of the present disclosure; and

FIG. 3 shows a method for tracking an object according to an illustrative embodiment of the present disclosure.

### DETAILED DESCRIPTION

The disclosure may be understood by reference to the following detailed description, taken in conjunction with the drawings as described below. It is noted that, for purposes of illustrative clarity, certain elements in various drawings may not be drawn to scale.

As will be appreciated by those skilled in the art, the devices and methods described herein for tracking an object can be used in a wide variety of applications and with a wide variety of objects. By way of non-limiting example, the devices and methods described herein can be used to track a personal asset, such as a package. By way of further non-limiting example, the devices and methods described herein can provide tracking functionality (e.g., positional information) via wireless communication with one or more other associated devices, such as a companion device (e.g., a mobile cellular device owned by the owner of the tracking device) with a secure connection/relationship with the tracking device (e.g., used to initially setup the tracking device) and/or one or more non-companion devices (e.g., mobile cellular devices) owned by non-owners of the tracking device (e.g., upon deployment of the tracking device). In certain embodiments, the companion device can initialize the tracking device (e.g., place the tracking device in a “tracking mode,” as described herein) using a mobile application of the companion device while in near proximity to the tracking device, although other embodiments are not necessarily so limited.

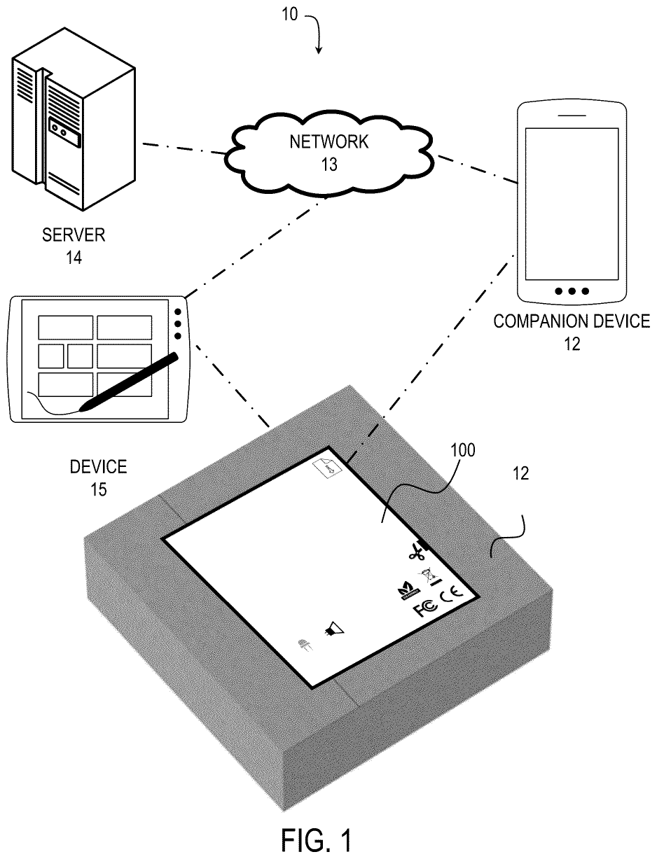

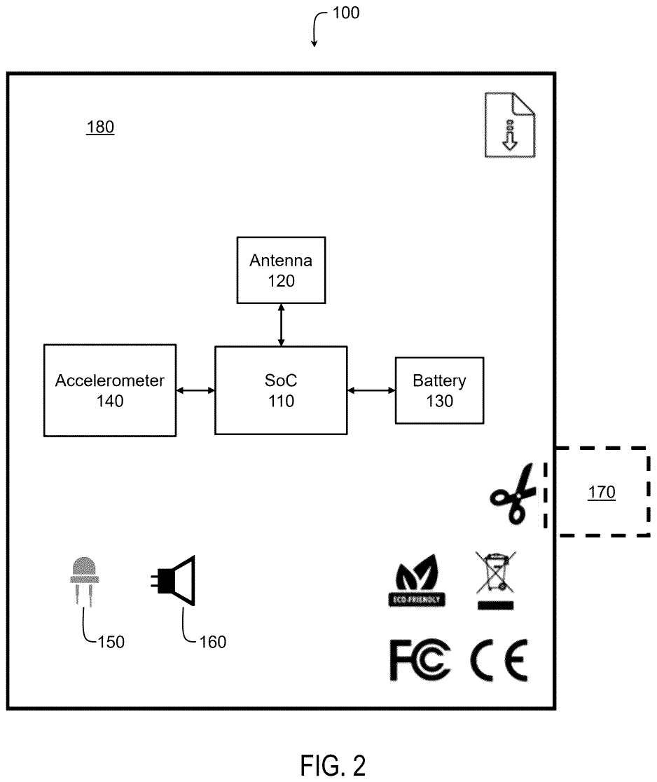

FIG. 1 illustrates an example system 10 for tracking an object according to one embodiment, and FIG. 2 illustrates an example tracking device 100 according to one embodiment. As illustrated, system 10 may include a tracking device 100 and an object 12 to which the tracking device 100 is attached. The system may further include a server 14. Server 14 may generally be any number of computing devices configured to effectuate the functionality described herein. The tracking device 100 may be configured to wirelessly communicate with one or more devices, such as a companion device 12 and/or a non-companion device 15. Generally, only a single companion device 12 is utilized, and the companion device 12 is a device with a secure connection/relationship with the tracking device (e.g., a mobile cellular device owned by the owner of tracking device 100 used to initially setup the tracking device to initialize tracking device 100 and place tracking device 100 in a “racking mode,” as described herein). In contrast, a large number of non-companion devices 15 may be utilized, and the non-companion devices 15 are devices (e.g., mobile cellular devices) owned by non-owners of tracking device 100 with which tracking device 100, which can be in wireless communication with tracking device 100 (e.g., to which tracking device 100 transmits one or more locations beacons, as described herein) upon deployment of tracking device 100 (e.g., after being attached to object 12 and object 12 is moved about), thereby sharing, determining, and/or updating a location of tracking device 100 via such wirelessly connected non-companion device(s) 15 for tracking object 12 to which tracking device 100 is attached.

As illustrated, tracking device 100 generally has a label-like form factor, such that the tracking device 100 is configured to be attached to a surface of the object 12. Tracking device 100 may, in certain embodiments, include a sticker-like surface, an adhesive backing, or the like configured to attach the tracking device 100 to a surface of the subject 12, such that the tracking device 100 remains attached to (e.g., adhered to) the object 12 as the object 12 is transported or otherwise moved.

With reference to FIG. 2, tracking device 100 includes a system-on-chip (SOC) 110 including an antenna 120 and wireless communication circuitry configured to facilitate wireless communication with the associated device (e.g., companion device 12 and/or one or more non-companion devices 15). In particular, tracking device 100 may include one or more processors configured to cause tracking device 100 to transmit a location beacon to the associated device to share, determine, and/or update a location of the tracking device 100 via the associated device In embodiments, wireless communication between tracking device 100 and the associated device can be implemented via any suitable protocol as desired to suit a particular application. In specific embodiments, it is contemplated that wireless communication between tracking device 100 and the associated device can be implemented via Bluetooth Low Energy (BLE) and/or near-filed communications (NFC) protocols. In embodiments, tracking device 100 can be configured to operate with or within the Apple “Find My” network and/or the Android “Find My Device” network.

In embodiments, upon receipt of the location beacon from tracking device 100, the associated device can generally be configured to provide (e.g., broadcast) positional information of tracking device 100 to server 14 (e.g., over network 13), and server 14 can generally be configured to receive and process (e.g., collect, categorize, and/or analyze) such positional information of tracking device 100, thereby facilitating tracking of object 12 to which tracking device 100 is attached.

In embodiments, it may be desirable to locate object 12 to which tracking device 100 is attached, and one or more signals may be sent to tracking device 100 to cause tracking device 100 to output a visual and/or an audible alert. In embodiments, tracking device 100 may include a light emitting diode 150 and/or a piezoelectric element 160 (e.g., speaker, buzzer), and one or more signals may be sent to tracking device 100 to cause tracking device 100 to output a visual alert via the light emitting diode 150 thereof and/or an audible alert via the piezoelectric element 160 thereof, such as to assist with locating tracking device 100, thereby locating object 12 to which tracking device 100 is attached. In embodiments, the light emitting diode 150 may advantageously provide additional functions, such as assisting with locating the tracking device 100 (and the object 12 to which tracking device 100 is attached) in low visibility environments (e.g., by providing a visual alert), quality control during manufacturing, visual confirmation tracking device 100 is powered on (e.g., in “tracking mode”) and/or transmitting location beacons (e.g., in response to initial displacement of a tearable portion of tracking device 100, as described herein), confirmation tracking device 100 is properly configured and ready for deployment, as a visual warning signal for unauthorized use, and the like, including combinations thereof. In embodiments, the piezoelectric element 160 (e.g., speaker, buzzer) may likewise advantageously provide additional functions, such as assisting with locating the tracking device 100 (and the object 12 to which tracking device 100 is attached) (e.g., by providing an audible alert), quality control during manufacturing, audible confirmation tracking device 100 is powered on (e.g., in “tracking mode”) and/or transmitting location beacons (e.g., in response to initial displacement of a tearable portion of tracking device 100, as described herein), confirmation tracking device 100 is properly configured and ready for deployment, as an audible warning signal for unauthorized use, and the like, including combinations thereof.

In embodiments, tracking device 100 may be powered by a battery 130, such as a flexible zinc ion battery. In embodiments, the battery 130 of tracking device 100 may be configured to be non-activated until a desired time (e.g., upon deployment of tracking device 100), as described herein. In such embodiments, tracking device 100 may not be caused to transmit any location beacons (e.g., enter “tracking mode”) until the battery 130 thereof is activated. In embodiments, tracking device 100 may include a tearable portion 170 configured to be displaced away from a main body portion 180 of tracking device 100, such as by being torn or cut away from the main body portion 180. As a result of initial displacement of the tearable portion 170 away from the main body portion 180, tracking device 100 may be activated (e.g., by activating battery 130). As a result, in embodiments, initial displacement of the tearable portion 170 away from the main body portion 180 may automatically cause battery 130 to begin powering tracking device 100, thereby putting tracking device 100 into “tracking mode.” In some embodiments, initial displacement of the tearable portion 170 away from the main body portion 180 may automatically cause tracking device 100 to begin transmitting one or more location beacons, as described herein. In embodiments, tracking device 100 may include motion detection circuitry, such as an accelerometer 140 configured to detect motion of tracking device 100.

In embodiments, tracking device 110 may be of a sufficiently thin size to permit tracking device 100 to function as a label attached (e.g., adhered) to an object to be tracked. By way of non-limiting example, tracking device 100 may have dimensions of about 70 mm×70 mm. For example, the battery 130 may have a thickness of about 0.8 mm or less, the accelerometer 140 may have a thickness of about 0.8 mm or less, the light emitting diode 150 may have a thickness of about 0.5 mm or less, and/or the piezoelectric element 160 may have a thickness of about 1 mm or less.

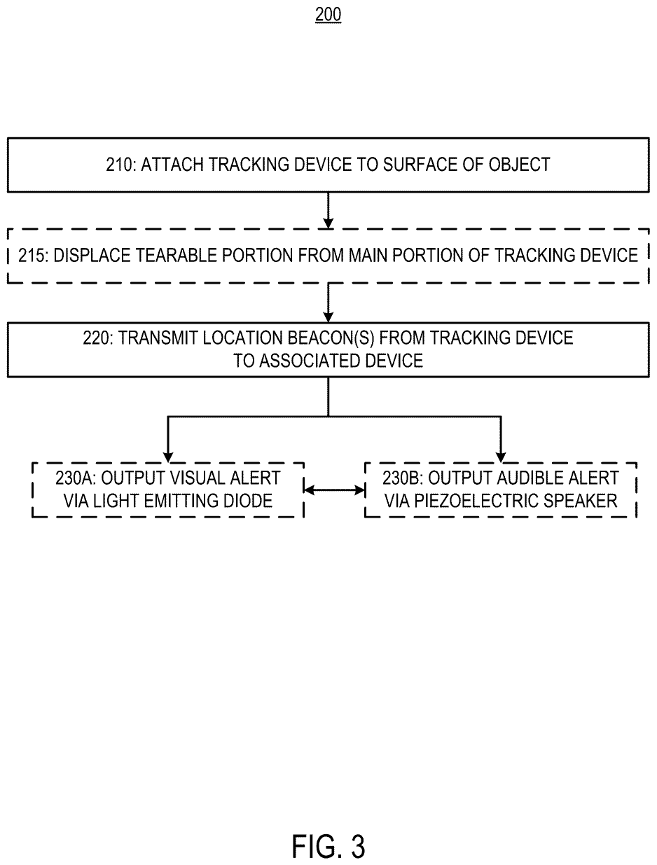

Turning to FIG. 3, an example methodology for tracking an object is illustrated according to one embodiment. Methodology 200 can be implemented using instructions stored on a non-transitory computer-readable medium that can be executed by a processor. Methodology 200 is described herein with specific reference to tracking device 100 illustrated in FIG. 2, although it will understood that methodology could be employed with other devices.

Methodology 200 start at step 210 where a tracking device (e.g., tracking device 100) having a label-like form factor is attached (e.g., adhered) to an object (e.g., object 12), as described herein.

At step 215, a tearable portion of the tracking device may be initially displaced from a main portion of the tracking device, thereby activating the tracking device (e.g., activating a battery of the tracking device). Initial displacement of the tearable portion away from the main body portion may automatically cause the battery to begin powering the tracking device, thereby putting the tracking device into “tracking mode.” Initial displacement of the tearable portion away from the main body portion may additionally or alternatively cause the tracking device to automatically begin transmitting one or more location beacons to an associated device (e.g., companion device 12 and/or one or more non-companion devices) for sharing, determining, and/or updating a location of the tracking device via the associated device, as described herein.

At step 220, one or more location beacons are transmitted from the tracking device to an associated device (e.g., companion device 12 and/or one or more non-companion devices) for sharing, determining, and/or updating a location of the tracking device via the associated device, as described herein.

The tracking device may output a visual alert via a light emitting diode thereof at step 230A and/or may output an audible alert via a piezoelectric element (e.g., speaker buzzer) thereof at step 230B, as described herein.

Various aspects disclosed herein are to be taken in the illustrative and explanatory sense and should in no way be construed as limiting of the present disclosure. All numerical terms, such as, but not limited to, “first” and “second” or any other ordinary or numerical terms, should also be taken only as identifiers, to assist the reader's understanding of the various aspects, variations, components, or modifications of the present disclosure, and may not generate any limitations, particularly as to the order, or preference, of any aspect, variation, component or modification relative to, or over, another aspect, variation, component or modification.

It is to be understood that individual features shown or described for one aspect may be combined with individual features shown or described for another aspect. The above-described implementation does not in any way limit the scope of the present disclosure. Therefore, it is to be understood although some features are shown or described to illustrate the use of the present disclosure in the context of functional segments, such features may be omitted from the scope of the present disclosure without departing from the spirit of the present disclosure as defined in the appended claims.

The present disclosure is described herein with reference to system architecture, block diagrams, flowchart illustrations of methods, and computer program products according to various aspects of the disclosure. It will be understood that each functional block of the block diagrams and the flowchart illustrations, and combinations of functional blocks in the block diagrams and flowchart illustrations, respectively, can be implemented by computer program instructions.

These software elements may be loaded onto a general-purpose computer, special purpose computer, or other programmable data-processing apparatus to produce a machine, such that the instructions that execute on the computer or other programmable data-processing apparatus generate means for implementing the functions specified in the flowchart block or blocks. These computer program instructions may also be stored in a computer-readable memory that can direct a computer or other programmable data-processing apparatus to function in a particular manner, such that the instructions stored in the computer-readable memory produce an article of manufacture including instruction means that implement the function specified in the flowchart block or blocks. The computer program instructions may also be loaded onto a computer or other programmable data-processing apparatus to cause a series of operational steps to be performed on the computer or other programmable apparatus to produce a computer-implemented process, such that the instructions that execute on the computer or other programmable apparatus provide steps for implementing the functions specified in the flowchart block or blocks. In an aspect, the computer program instructions may be executed on any remote-hosted application framework, for example, by a processor associated with a cloud server.

Accordingly, functional blocks of the block diagrams and flow diagram illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, web pages, websites, web forms, prompts, etc. Practitioners will appreciate that the illustrated steps described herein may comprise in any number of configurations including the use of windows, web pages, hypertexts, hyperlinks, web forms, popup windows, prompts, and the like. It should be further appreciated that the multiple steps as illustrated and described may be combined into single web pages and/or windows but have been expanded for the sake of simplicity. In other cases, steps illustrated and described as single process steps may be separated into multiple web pages and/or windows but have been combined for simplicity.

The systems, methods and computer program products disclosed in conjunction with various aspects of the present disclosure are embodied in systems and methods for facilitating multiple types of communications via a network based portal. While aspects of the present disclosure have been particularly shown and described with reference to the examples above, it will be understood by those skilled in the art that various combinations of the disclosed aspects or additional aspects may be contemplated by the modification of the disclosed machines, systems and methods without departing from the spirit and scope of what is disclosed. Such aspects should be understood to fall within the scope of the present disclosure as determined based upon the claims and any equivalents thereof.

Having described several embodiments, it will be recognized by those skilled in the art that various modifications, alternative constructions, and equivalents may be used without departing from the spirit of the invention. Additionally, a number of well-known processes and elements have not been described in order to avoid unnecessarily obscuring the invention. Accordingly, the above description should not be taken as limiting the scope of the invention.

Those skilled in the art will appreciate that the presently disclosed embodiments teach by way of example and not by limitation. Therefore, the matter contained in the above description or shown in the accompanying drawings should be interpreted as illustrative and not in a limiting sense. The following claims are intended to cover all generic and specific features described herein, as well as all statements of the scope of the method and system, which, as a matter of language, might be said to fall therebetween.

What is claimed is:

1. A tracking device, comprising:
a system-on-chip comprising wireless communication circuitry configured to facilitate wireless communication with an associated device; and
one or more processors coupled to the wireless communication circuitry and configured to cause the tracking device to transmit a location beacon to the associated device for updating a location of the tracking device via the associated device,
wherein the tracking device has a label-like form factor, such that the tracking device is configured to be attached to a surface of an object.

2. The tracking device of claim 1, wherein the wireless communication circuitry comprises an antenna.

3. The tracking device of claim 1, wherein the system-on-chip further comprises an accelerometer configured to detect motion of the tracking device.

4. The tracking device of claim 1, wherein the one or more processors are configured to transmit the location beacon via Bluetooth low energy.

5. The tracking device of claim 1, wherein the one or more processors are configured to transmit the location beacon via near-field communications.

6. The tracking device of claim 1, further comprising a light emitting diode.

7. The tracking device of claim 6, wherein the one or more processors are further configured to cause the tracking device to output a visual alert via the light emitting diode.

8. The tracking device of claim 1, further comprising a piezoelectric element selected from the group consisting of a speaker and a buzzer.

9. The tracking device of claim 8, wherein the one or more processors are further configured to cause the tracking device to output an audible alert via the piezoelectric element.

10. The tracking device of claim 1, further comprising a battery.

11. The tracking device of claim 10, wherein the battery is a flexible zinc ion battery.

12. The tracking device of claim 1, further comprising a tearable portion configured to be displaced from a main portion of the tracking device.

13. The tracking device of claim 12, further comprising a battery, wherein the one or more processors are configured to automatically cause the battery to begin powering the tracking device upon initial displacement of the tearable portion from the main portion of the tracking device.

14. The tracking device of claim 12, wherein the one or more processors are configured to automatically begin transmitting the location beacon to the associated device upon initial displacement of the tearable portion from the main portion of the tracking device.

15. A method for tracking an object, comprising:
attaching a tracking device having a label-like form factor to a surface of the object; and
transmitting a location beacon from the tracking device to an associated device in wireless communication with the tracking device for updating a location of the tracking device via the associated device.

16. The method of claim 15, further comprising outputting a visual alert via a light emitting diode of the tracking device.

17. The method of claim 15, further comprising outputting an audible alert via a piezoelectric element of the tracking device.

18. The method of claim 15, further comprising initially displacing a tearable portion of the tracking device from a main portion of the tracking device to automatically cause a battery of the tracking device to begin powering the tracking device.

19. A tracking device, comprising:
a system-on-chip comprising wireless communication circuitry comprising an antenna and configured to facilitate wireless communication with an associated device;
a flexible zinc ion battery;
a light emitting diode;
a piezoelectric element selected from the group consisting of a speaker and a buzzer;
a tearable portion; and
one or more processors coupled to the wireless communication circuitry and configured to cause the tracking device to:
automatically begin powering the tracking device, using the battery, upon initial displacement of the tearable portion from a main portion of the tracking device;
automatically transmit a location beacon to the associated device via Bluetooth low energy or near-field communications for updating a location of the tracking device via the associated device; and
output a visual alert via the light emitting diode and/or an audible alert via the piezoelectric element,
wherein the tracking device has a label-like form factor, such that the tracking device is configured to be attached to a surface of an object.

20. The tracking device of claim 19, wherein the battery has a thickness of about 0.8 mm or less, the light emitting diode 150 has a thickness of about 0.5 mm or less, and the piezoelectric element has a thickness of about 1 mm or less.
